(19) United States
(12) Patent Application Publication
(10) Pub. No.: US 2008/0247587 A1
(43) Pub. Date: Oct. 9, 2008

(54) Condenser microphone, S/N ratio improvement therefor, and electronic device therefor

(75) Inventor: Akiyoshi Sato, Hamamatsu-shi (JP)

Correspondence Address: PILLSBURY WINTHROP SHAW PITTMAN LLP, P.O BOX 10500, McLean, VA, 22102, US

(73) Assignee: Yamaha Corporation, Hamamatsu-shi (JP)

(21) Appl. No.: 12/080,312

(22) Filed: Apr. 2, 2008

(30) Foreign Application Priority Data
Apr. 5, 2007 (JP) 2007-099683

(51) Int. Cl. H04R 11/04

(52) U.S. Cl. 381/365

(57) ABSTRACT

A condenser microphone includes a microphone chip and an LSI chip, which are stored in a microphone package having a sound hole. External sound enters the sound hole so as to propagate through the internal space of the microphone package, so that it is received by the microphone chip. The microphone package is designed to set the Helmholtz resonance frequency within the audio frequency range. The output signal of the microphone chip is supplied to an impedance converter included in the LSI chip. The output signal of the impedance converter is attenuated by an attenuation device with respect to the prescribed frequency band including the Helmholtz resonance frequency, which decreases when the condenser microphone is installed in the housing of an electronic device. Thus, it is possible to achieve the flat frequency characteristics in the output signal of the condenser microphone, which is thus improved in the S/N ratio.

### BACKGROUND OF THE INVENTION

1. Field of the Invention

The present invention relates to condenser microphones such as electret condenser microphones and to improvements of the S/N ratios of condenser microphones. The present invention also relates to electronic devices incorporating condenser microphones.

The present application claims priority on Japanese Patent Application No. 2007-99683, the content of which is incorporated herein by reference.

2. Description of the Related Art

It is required that microphones incorporated into cellular phones be reduced in size and weight. To cope with such requirement, silicon microphones (or MEMS microphones, wherein MEMS stands for Micro Electro Mechanical System), which are condenser microphones manufactured based on the MEMS technology, have been developed and installed in electronic devices.

Non-Patent Document 1: “Microphone Handbook”, Vol. 1, Bruel & Kjaer, pp. 4-8 to 4-11.

Condenser microphones have high impedances, so that output signals thereof are extracted via impedance converters, which are configured by field-effect transistors (FET) and bias resistors (which are connected in proximity to input terminals and whose resistances range from several giga-ohms to several tera-ohms). FETs and bias resistors cause thermal noises (or white noises), which reduce S/N ratios. Non-Patent Document 1 describes noise generated by an impedance converter attached to a condenser microphone.

### SUMMARY OF THE INVENTION

It is an object of the present invention to provide a condenser microphone that has an improved S/N ratio.

It is another object of the present invention to provide a method for improving the S/N ratio of a condenser microphone.

It is a further object of the present invention to provide an electronic device incorporating a condenser microphone having an improved S/N ratio.

In a first aspect of the present invention, the S/N ratio of a condenser microphone, including a microphone chip, which is stored in a microphone package so as to receive an external sound propagated thereto via a sound hole of the microphone package, is improved in such a way that a resonance frequency of Helmholtz resonance, which occurs due to the sound hole and an internal space of the microphone package, is set to an audio frequency range; the output signal of the microphone chip is supplied to an impedance converter; then, the output signal of the impedance converter is attenuated selectively with respect to a prescribed frequency band including the resonance frequency, thus achieving flat frequency characteristics.

That is, the microphone chip receives the external sound of an increased level in the prescribed frequency band including the resonance frequency due to the Helmholtz resonance, wherein the prescribed frequency band of an increased level is attenuated so as to achieve flat frequency characteristics. Therefore, noise generated by the impedance converter is attenuated with respect to the prescribed frequency band. Thus, it is possible to improve the S/N ratio of the condenser microphone.

The condenser microphone can be installed in a housing of an electronic device such that the sound hole of the microphone package storing the microphone chip is communicated with a sound hole of the housing, wherein an external sound propagates through the sound hole of the housing, the sound hole of the microphone package, and the internal space of the microphone package so as to reach the microphone chip. The S/N ratio of the condenser microphone installed in the electronic device is improved in such a way that the resonance frequency of Helmholtz resonance, which occurs due to the sound hole of the housing, the sound hole of the microphone package, and the internal space of the microphone package, is set to the audio frequency range. The output signal of the microphone chip is supplied to the impedance converter; then, the output signal of the impedance converter is attenuated with respect to the prescribed frequency band including the resonance frequency, thus achieving the flat frequency characteristics.

In the above, the resonance frequency ranges from 500 kHz to 10 kHz, and preferably, the resonance frequency is set to 6 kHz±1 kHz.

In a second aspect of the present invention, a condenser microphone includes a microphone package having a sound hole and an internal space, in which the microphone package is designed such that the resonance frequency of Helmholtz resonance is set to an audio frequency range, a microphone chip that is stored in the microphone package so as to receive the external sound entering the sound hole via the internal space of the microphone package, an impedance converter for performing impedance conversion on the output signal of the microphone chip, and an attenuation device for selectively attenuating the output signal of the impedance converter with respect to the prescribed frequency band including the resonance frequency, thus achieving flat frequency characteristics.

The condenser microphone can be installed in a housing of an electronic device such that the sound hole of the microphone package storing the microphone chip is communicated with a sound hole of the housing, wherein an external sound propagates through the sound hole of the housing, the sound hole of the microphone package, and the internal space of the microphone package so as to reach the microphone chip. The S/N ratio of the condenser microphone installed in the electronic device is improved in such a way that the resonance frequency of Helmholtz resonance, which occurs due to the sound hole of the housing, the sound hole of the microphone package, and the internal space of the microphone package, is set to the audio frequency range. The impedance converter performs impedance conversion on the output signal of the microphone chip; then, the attenuation device selectively attenuates the output signal of the impedance converter with respect to the prescribed frequency band including the resonance frequency, thus achieving flat frequency characteristics.

In the above, a gasket can be inserted between the microphone package of the condenser microphone and the housing of the electronic device so that the sound hole of the microphone package communicates with the sound hole of the housing via the opening of the gasket.

Both the impedance converter and the attenuation device are arranged in the internal space of the microphone package. Compared with the arrangement, in which the impedance converter and the attenuation device are arranged externally of the microphone package and are connected to the microphone chip via signal lines, it is possible to prevent external noise such as radio waves from entering into microphone signals via signal lines.

The attenuation device includes a band-pass filter for extracting the prescribed frequency band including the resonance frequency from the output signal of the impedance converter, and a subtracter for subtracting the prescribed frequency band extracted by the band-pass filter from the output signal of the microphone chip so as to feed back the subtraction result thereof to the impedance converter.

Alternatively, the attenuation device includes a subtracter for inputting the output signal of the impedance converter and a band-pass filter for extracting the prescribed frequency band including the resonance frequency from the output signal of the subtracter. The subtracter subtracts the extracted signal of the band-pass filter from the output signal of the impedance converter, so that the output signal of the subtracter has the flat frequency characteristics.

Alternatively, the attenuation device includes a band-attenuation filter for attenuating the prescribed frequency band including the resonance frequency from the output signal of the impedance converter, wherein the output signal of the band-attenuation filter has the flat frequency characteristics.

Alternatively, the attenuation device has a plurality of attenuation characteristics, one of which is selectively applied to the microphone signal. The attenuation device has a plurality of attenuation values, which are set to a plurality of frequency bands within the audio frequency range.

In a third aspect of the present invention, an electronic device having a housing is designed to incorporate the condenser microphone. Herein, the sound hole of the microphone package communicates with the sound hole of the housing, wherein the S/N ratio of the condenser microphone is improved such that the resonance frequency of Helmholtz resonance is set to the audio frequency range. The microphone chip receives an external sound propagated thereto via the sound hole of the housing, the sound hole of the microphone package, and the internal space of the microphone package. The impedance converter performs impedance conversion on the output signal of the microphone chip; then, the attenuation device selectively attenuates the output signal of the impedance converter with respect to the prescribed frequency band including the resonance frequency, thus achieving the flat frequency characteristics.

### BRIEF DESCRIPTION OF THE DRAWINGS

These and other objects, aspects, and embodiments of the present invention will be described in more detail with reference to the following drawings, in which:

FIG. 1 is a circuit diagram showing the electric circuitry of a silicon microphone including a microphone chip and an LSI chip in accordance with a preferred embodiment of the present invention;

FIG. 2A is a plan view of the silicon microphone;

FIG. 2B is a longitudinal sectional view of the silicon microphone;

FIG. 3 is a plan view showing a modified example of the silicon microphone;

FIG. 4 is a circuit diagram showing an electric equivalent circuit of a microphone package of the silicon microphone serving as a Helmholtz resonator;

FIG. 5 is a graph showing the acoustic correction characteristics;

FIG. 6 is a graph showing the measurement of acoustic frequency characteristics of the microphone package according to Design 1;

FIG. 7 is a circuit diagram showing an equivalent circuit representing the configuration of the LSI circuit of the silicon microphone;

FIG. 8 is an illustration showing the z-plane representation of the frequency characteristics with regard to the term “z/(z+a)” in equation (8);

FIG. 9A is a graph showing the frequency characteristics of an external sound;

FIG. 9B is a graph showing the frequency characteristics of an audio signal output from the microphone chip of the silicon microphone receiving the external sound;

FIG. 9C is a graph showing the frequency characteristics of an audio signal output from the LSI chip without feedback from a band-pass filter;

FIG. 9D is a graph showing a prescribed frequency band including a resonance frequency fc extracted by the band-pass filter;

FIG. 9E is a graph showing the frequency characteristics of an audio signal output from the LSI chip accompanied with the feedback from the band-pass filter;

FIG. 10 is a circuit diagram showing a modified example of the electric circuitry of the silicon microphone;

FIG. 11A is a graph showing the frequency characteristics of an external sound;

FIG. 11B is a graph showing the frequency characteristics of an audio signal output from the microphone chip of the silicon microphone of FIG. 10 receiving the external sound;

FIG. 11C is a graph showing the frequency characteristics of an audio signal output from the LSI chip of the silicon microphone of FIG. 10;

FIG. 11D is a graph showing the frequency characteristics of an audio signal output from a band-attenuation filter included in the silicon microphone of FIG. 10;

FIG. 12 is a longitudinal sectional view showing the constitution of a cellular phone incorporating the silicon microphone;

FIG. 13 is a circuit diagram showing the electric circuitry of the silicon microphone shown in FIG. 12;

FIG. 14 is a perspective view showing an example of a microphone package adapted to the silicon microphone;

FIG. 15 is a graph showing the frequency characteristics of the silicon microphone and the frequency characteristics of the silicon microphone installed in the housing of the cellular phone without filtering;

FIG. 16 is a graph showing the filter characteristics, which are determined based on the frequency characteristics of the silicon microphone installed in the housing of the cellular phone, and the output characteristics of the silicon microphone installed in the housing of the cellular phone with filtering; and

FIG. 17 is a block diagram showing the constitution of a band-attenuation filter included in the LSI chip of the silicon microphone shown in FIG. 10.

### DESCRIPTION OF THE PREFERRED EMBODIMENT

The present invention will be described in further detail by way of examples with reference to the accompanying drawings.

### (A) Microphone Package

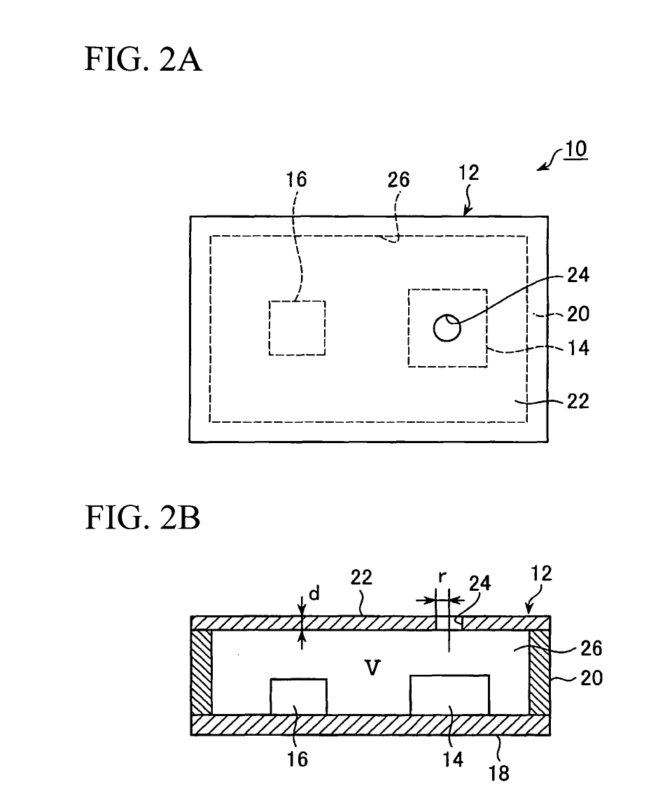

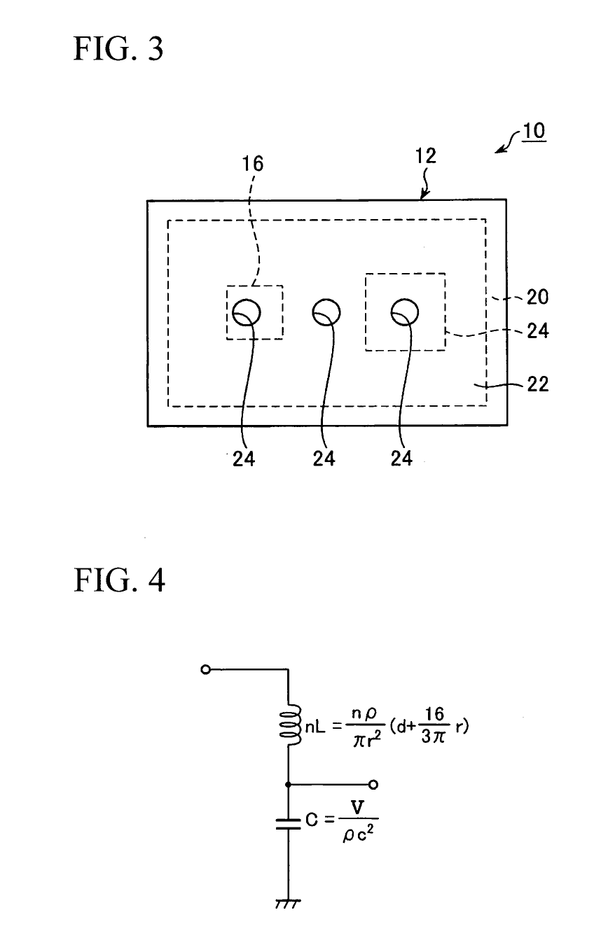

The mechanical constitution of a silicon microphone 10 will be described with reference to FIGS. 2A and 2B. FIG. 2A is a plan view of the silicon microphone 10, and FIG. 2B is a longitudinal sectional view showing the internal structure of the silicon microphone 10. The silicon microphone 10 includes a microphone chip (or an MEMS chip) 14 and an LSI chip 16, which are encapsulated in a microphone package 12. The microphone package 12 is constituted of a bottom 18 (i.e., a substrate having printed circuitry), side walls 20 composed of metals, and a cover 22 composed of a thin metal plate. The microphone chip 14 and the LSI chip 16 are fixed onto the surface of the substrate 18. A sound hole 24 having a circular shape is opened at a prescribed position of the cover 22. External sound enters via the sound hole 24 so as to propagate through an internal space 26 of the microphone package 12, so that it reaches a sound-reception surface (i.e., a diaphragm composed of a silicon film) of the microphone chip 14. The LSI chip 16 includes an impedance converter, a filter, etc.; hence, it performs impedance conversion and filtering on the output signal of the microphone chip 14. The output signal of the LSI chip 16 is extracted via a terminal (not shown) formed in the backside of the substrate 18 and is then supplied to an external circuit (e.g., an amplifier). A single sound hole 24 is not limited to be formed in the cover 22; hence, as shown in FIG. 3, it is possible to form multiple (e.g., three) sound holes 24 in the cover 22. The aforementioned filter is not necessarily incorporated in the LSI chip 16; hence, it can be arranged as an independent component mounted on the substrate 18.

Helmholtz resonance occurs in the microphone package 12 by way of the sound hole 24 and the internal space 26. That is, the microphone package 12 is designed such that Helmholtz resonance occurs at a prescribed resonance frequency within the audio frequency range. Next, the Helmholtz resonance frequency of the microphone package 12 will be explained below. An electric equivalent circuit of the microphone package 12 serving as a Helmholtz resonator is expressed in the form of an LC resonance circuit shown in FIG. 4. That is, the resonance frequency fc of the microphone package 12 serving as the Helmholtz resonator is expressed by an equation (1) as follows:

$$fc = \frac{1}{2 {π ( nLC )}^{1 / 2}} \qquad ( 1 )$$

where n denotes the number of the sound hole(s) 24, i.e., n=1, 2, 3, . . . .

In this connection, various parameters and variables are defined as follows: V: The volume of the internal space 26 of the microphone package 12 (excluding the volumes of the microphone chip 14, the LSI chip 16, and their potting agents) (m³)

d: The thickness of the cover 22 having the sound hole 24 (m).

r: The radius of the sound hole 24 (m).

ρ: The air density (≈1.25 kg/m³)

c: The speed of sound in the air (≈340 m/sec)

Using the aforementioned numerals, the terms “nL” and “C” are expressed in equations (2) and (3) as follows:

$$\begin{matrix}nL = ( \frac{n ρ}{π {r}^{2}} ) \times ( d + \frac{16 r}{3 π} ) & ( 2 ) \\ C = \frac{V}{ρ {c}^{2}} & ( 3 )\end{matrix}$$

In order to reduce the resonance frequency fc in the equation (1), it is necessary to increase the number “n” of the sound hole(s) 24 or to increase the value of L or C. According to the equation (2), in order to increase the value of L under the condition in which the same number “n” of the sound hole(s) 24 is sustained, it is necessary to reduce the radius r of the sound hole 24 or to increase the thickness d of the cover 22. According to the equation (3), in order to increase the value of C, it is necessary to increase the volume V of the internal space 26 of the microphone package 12.

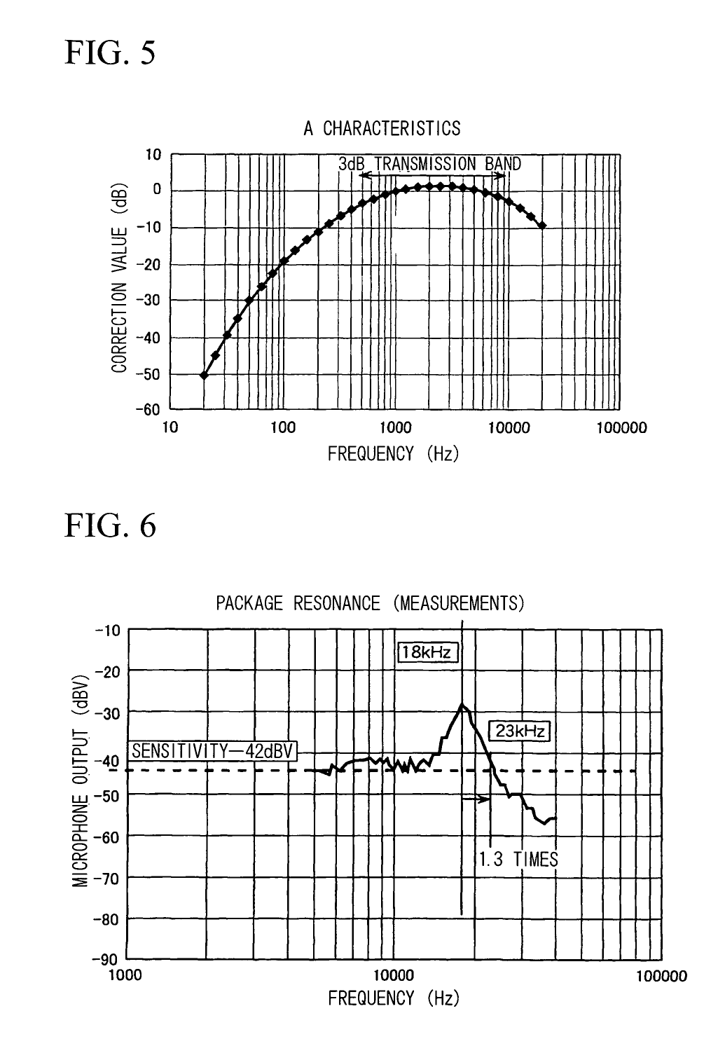

Next, actual values of the resonance frequency fc of the microphone package 12 will be explained. FIG. 5 shows acoustic correction characteristics (referred to as A characteristics). The 3 dB transmission band of the A characteristics ranges approximately from 500 Hz to 10 kHz; hence, it is preferable that the resonance frequency fc be in this range. Even though the resonance frequency fc is out of the 3 dB transmission band, it may be possible to produce a noise reduction effect as long as it belongs to the audio frequency range, in which the noise reduction effect must be decreased in comparison with the 3 dB transmission band. It is expected that the maximum noise reduction effect can be realized by setting the resonance frequency fc to the peak frequency (i.e., 2.5 kHz) of the A characteristics, wherein flat characteristics may be realized in a certain frequency range up to 3.2 kHz (approximately 1.3 times higher than 2.5 kHz). When the silicon microphone 10 is applied to a small-size terminal (substantially designed to receive sound) such as a cellular phone, it is preferable that flat characteristics be maintained substantially within the frequency range between 200 Hz and 8 kHz. In this case, it is preferable that the resonance frequency fc be set to approximately 6 kHz (e.g., 6 kHz±1 kHz).

Next, actual designs of the microphone package 12 will be described below.

### 1. Design 1

r (radius of the sound hole 24): 0.35 mm

n (number of the sound hole 24): 1

V (volume of the internal space 26 of the microphone package 12): 3.83×10⁻⁹ m³

D (thickness of the cover 22): 0.1 mm

According to the Design 1, the calculated value of the resonance frequency fc is approximately 20 kHz. FIG. 6 shows the measurement of acoustic frequency characteristics according to the Design 1, in which the measured value of the resonance frequency fc is approximately 18 kHz, which is lower than the calculated value, wherein the resonance peak range extends to 23 kHz (which is 1.3 times higher than the resonance frequency fc) in the higher range higher than the resonance frequency fc.

### 2. Design 2

r (radius of the sound hole 24): 0.05 mm

n (number of the sound holes 24): 3

V (volume of the internal space 26 of the microphone package 12): 3.83×10⁻⁹ m³

d (thickness of the cover 22): 0.1 mm

According to the Design 2, the calculated value of the resonance frequency fc is approximately 2.5 kHz.

### 3. Design 3

r (radius of the sound hole 24): 0.1 mm

n (number of the sound holes 24): 5

V (volume of the internal space 26 of the microphone package 12): 3.83×10⁻⁹ m³

d (thickness of the cover 22): 0.1 mm

According to the Design 3, the calculated value of the resonance frequency fc is approximately 5.5 kHz.

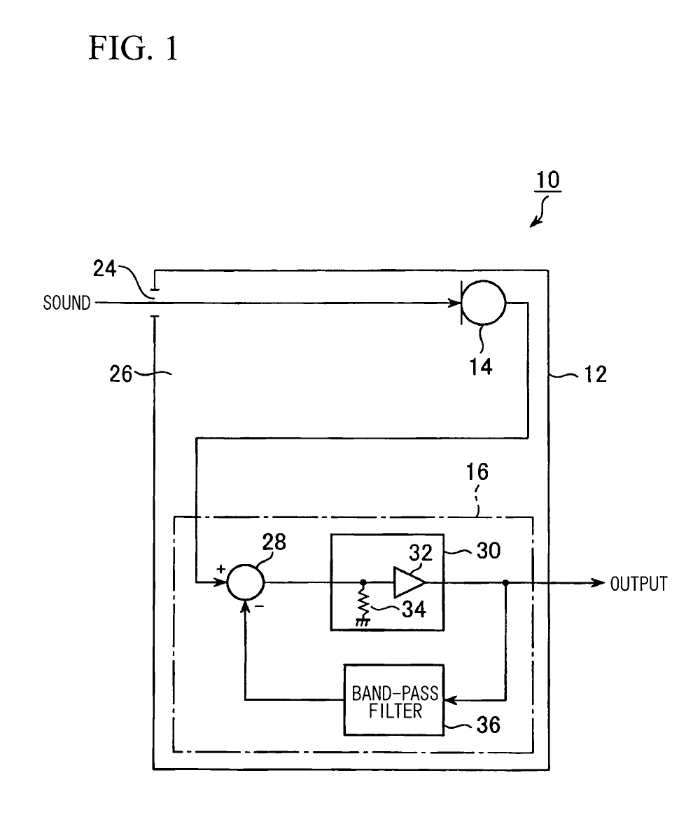

FIG. 1 shows the electric circuitry of the silicon microphone 10 having the aforementioned mechanical constitution (power system not shown). The external sound enters into the sound hole 24 of the microphone package 12 of the silicon microphone 10 and is then received by the microphone chip 14 via the internal space 26. The output signal of the microphone chip 14 is forwarded to the LSI chip 16, in which it is supplied to an impedance converter 30 via a subtracter 28 and is thus subjected to impedance conversion. The impedance converter 30 is constituted of a buffer amplifier 32 (configured using FETs) and a bias resistor (whose resistance ranges from several gia-ohms to several tera-ohms and which is connected to an input terminal thereof). Thermal noise (or white noise) is generated by the buffer amplifier 32 and the bias resistor 34 so as to reduce the S/N ratio of the output signal of the condenser microphone 10.

The output signal of the impedance converter 30 is supplied to a band-pass filter 36, which in turn extracts prescribed components of frequencies including the resonance frequency fc. The extracted frequency components are subjected to gain adjustment as necessary and are then fed back to the subtracter 28. The subtracter 28 subtracts components of frequencies including the resonance frequency fc from the input signal thereof so as to selectively attenuating frequency components regarding the resonance frequency fc within the input signal, thus realizing flat frequency characteristics. Thermal noise generated by the impedance converter 30 is inverted in polarity and is then fed back to the impedance converter 30. Thermal noise is white noise regarding all frequencies. For this reason, when the delay time (i.e., the time constant) of the band-pass filter 36 is adequately reduced, the correlation between thermal noise generated by the impedance converter 30 and the feedback signal of the subtracter 28 is enhanced in the low frequency range (i.e., the transmission band of the band-pass filter 36), which is lower than the frequency dependent upon the time constant (i.e., the frequency higher than the transmission band of the band-pass filter 36). That is, the feedback signal is inverted by the subtracter 28 and is then supplied to the impedance converter 30, thus canceling out the thermal noise generated by the impedance converter 30. This attenuates frequency components (whose frequencies are proximity to the resonance frequency fc) within the thermal noise generated by the impedance converter 30. As a result, the silicon microphone 10 outputs signals having flat frequency characteristics, in which frequency components (whose frequencies are proximate to the resonance frequency fc) within the thermal noise are attenuated.

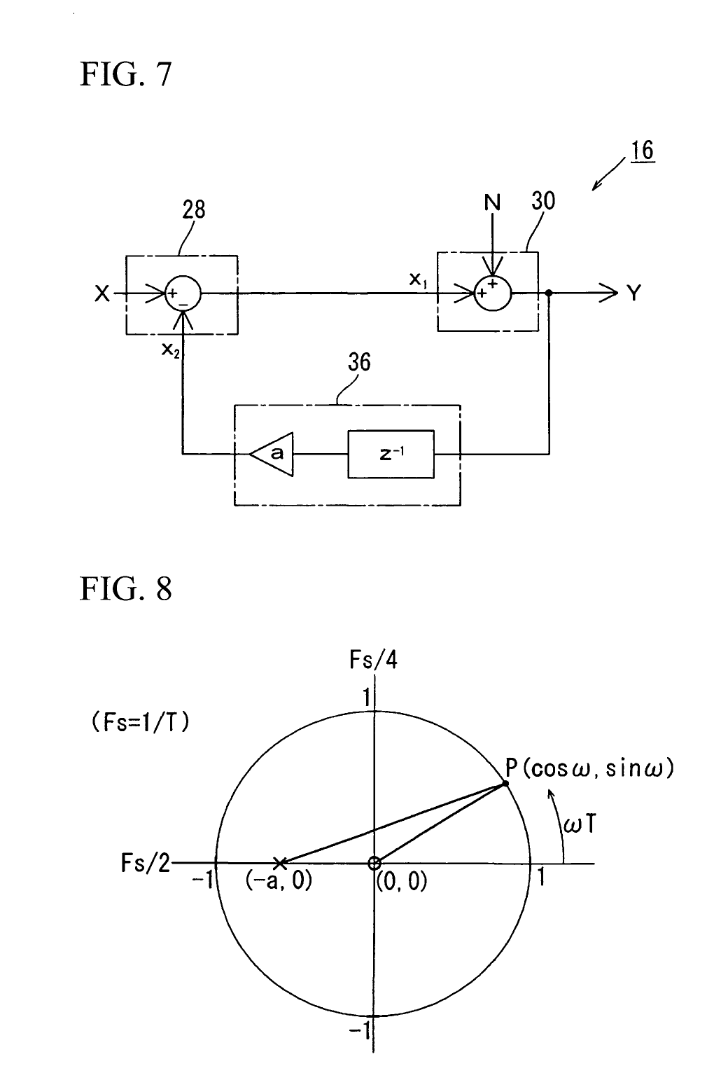

Next, the detailed description will be given with respect to the mechanism in which the input signal of the LSI chip 16 has flat characteristics due to the feedback circuit including the band-pass filter 36 so as to attenuate thermal noise generated by the impedance converter 30. FIG. 7 is a circuit model representing the configuration of the LSI chip 16, which is expressed using the following parameters.

X: input signal of the LSI chip 16.

Y: output signal of the LSI chip 16.

x1: input signal of the impedance converter 30.

x2: feedback signal of the subtracter 28.

N: noise generated by the impedance converter 30.

a: gain of the band-pass filter 36 (a≠1)

For the sake of simplification of the following description, the band-pass filer 36 is delayed by a unit time T.

FIG. 7 shows the following equations (4), (5), and (6).

x1=X−x2 (4)

x2=z⁻¹aY (5)

Y=N+x1 (6)

The equation (5) is substituted for the equation (4) as follows:

x1=X−z⁻aY (7)

The equation (7) is substituted for the equation (6) as follows:

$$Y = N + X - {z}^{- 1} aY \\ ( 1 + {az}^{- 1} ) Y = N + X \\ ∴ Y = \frac{z}{z + a} \cdot ( N + X ) \qquad ( 8 )$$

FIG. 8 shows a z-plane representation of frequency characteristics regarding the term “z/(z+a)”. In FIG. 8, Fs denotes the sampling frequency, i.e., Fs=1/T (where T denotes the unit time). In view of FIG. 8, an amplitude response M(ωT) of z/(z+a) is calculated as follows:

$$M ( ω T ) = \frac{1}{{[ {( cos ω T + a )}^{2} + {sin}^{2} ω T ]}^{1 / 2}} = \frac{1}{{( 1 + 2 a \cdot cos ω T + {a}^{2} )}^{1 / 2}}$$

When the unit time T is adequately small, the aforementioned equation can be approximated using cosωT≈1 (i.e., Fs>>audio frequency range) in the following equation.

M(ωT)≈1/(1+a)

This indicates that, by adjusting the gain “a” of the band-pass filter 36, it is possible to control the amplitude of N (representing noise generated by the impedance converter 30) and the amplitude of X (representing the input signal of the LSI chip 16). Due to the provision of the feedback circuit using the band-pass filter 36, it is possible to control the amplitudes of N and X in a certain band (e.g., the transmission band of the band-pass filter 36), wherein a=0 is presumably set to frequency bands other than the transmission band. By setting the transmission band of the band-pass filter 36 to match the prescribed band embracing the resonance frequency fc (i.e., the band in which the input signal X is increased in level due to resonance), it is possible to realize flatness in the level of the input signal X and to attenuate thermal noise generated by the impedance converter 30.

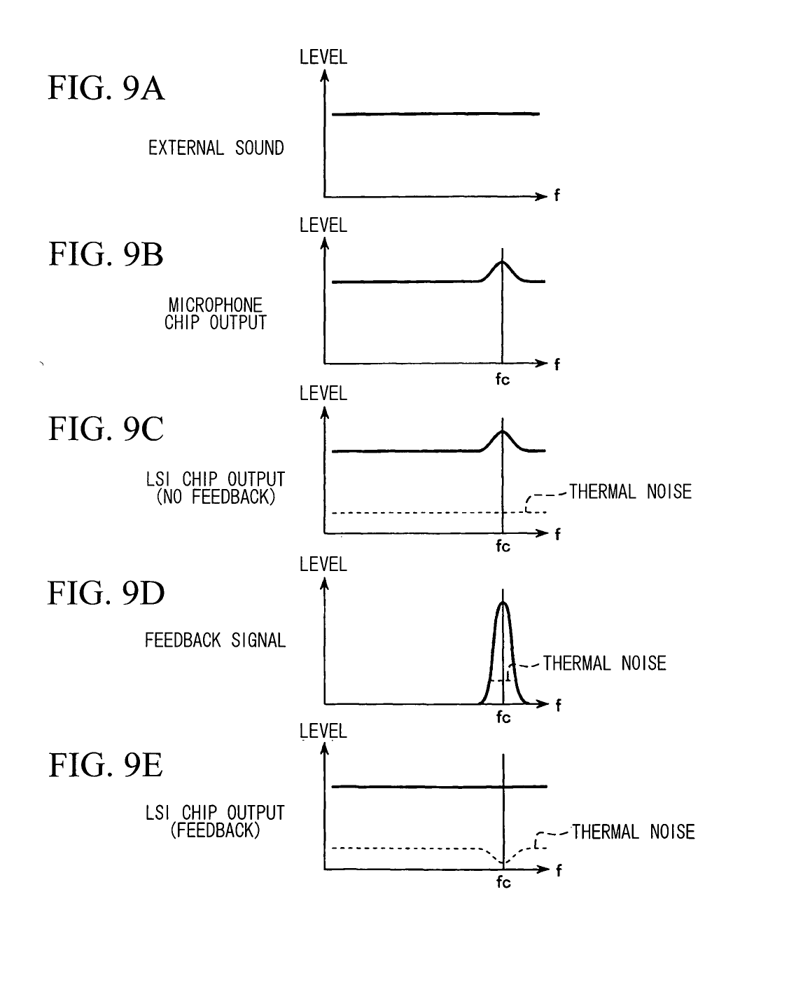

The operation of the circuitry shown in FIG. 1 will be described with reference to FIGS. 9A to 9E, which show the frequency characteristics in the audio frequency band. FIG. 9A shows the frequency characteristics of an external sound, which are presumably flat characteristics. FIG. 9B shows the frequency characteristics of an audio signal output from the microphone chip 14 of the silicon microphone 10 receiving the external sound, in which frequency components of the resonance frequency fc increases in level due to the resonance of the microphone package 12. FIG. 9C shows the frequency characteristics of an audio signal output from the LSI chip 16 without feedback from the band-pass filter 36, wherein a dotted line indicates thermal noise generated by the FET and the bias resistor 34 of the buffer amplifier 32 within the LSI chip 16. FIG. 9D shows a prescribed frequency band including the resonance frequency fc extracted by the band-pass filter 36, wherein thermal noise represented by a dotted line is simultaneously extracted. FIG. 9E shows frequency characteristics of an audio signal output from the LSI chip 16 accompanied with feedback from the band-pass filter 36. The subtracter 28 subtracts a feedback signal including components of the resonance frequency fc from an input signal in which components of the resonance frequency fc are increased, thus selectively attenuating the prescribed frequency band including the resonance frequency in the input signal in level by a prescribed value. Thus, the subtracter 28 outputs signals having flat frequency characteristics. At the same time, thermal noise generated by the impedance converter 30 is attenuated in level with respect to the prescribed frequency band proximate to the resonance frequency fc. Thus, it is possible to improve the S/N ration in the output signal of the silicon microphone 10.

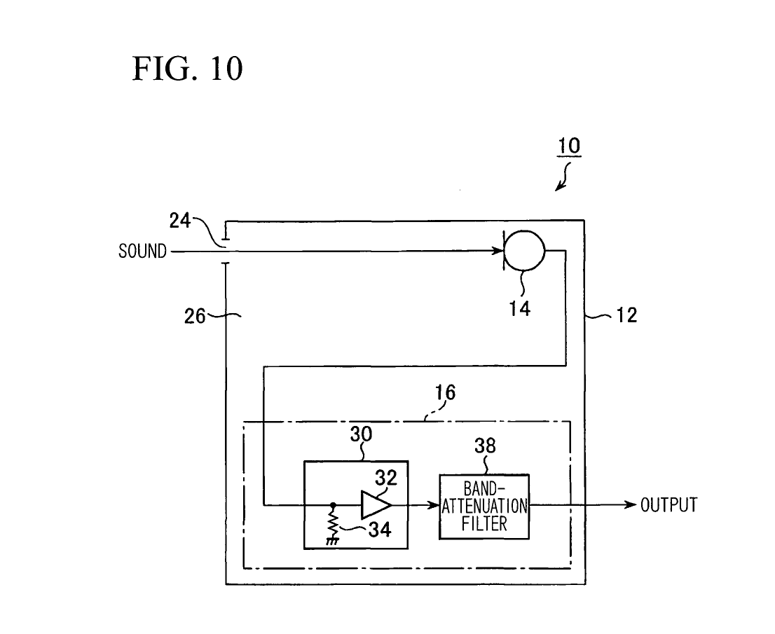

The present embodiment can be further modified in a variety of ways. FIG. 10 shows a modified example of the electric circuitry of the silicon microphone 10 (excluding the power system in illustration), wherein parts identical to those shown in FIG. 1 are designated by the same reference numerals. An external sound enters into the silicon microphone 10 shown in FIG. 10 via the sound hole 24 of the microphone package 12 so as to propagate through the internal space 26 and then received by the microphone chip 14. The output signal of the microphone chip 14 is forwarded to the LSI chip 16 and is then subjected to impedance conversion by the impedance converter 30. The impedance converter 30 is constituted by the buffer amplifier 32 (including the FET) and the bias resistor 34 connected to the input terminal thereof, wherein thermal noise generated by the FET of the buffer amplifier 32 and the bias resistor 34 reduces the S/N ratio of the output signal of the silicon microphone 10.

The output signal of the impedance converter 30 is supplied to a band-attenuation filter 38, which selectively attenuates the prescribed frequency band including the resonance frequency fc in level by a prescribed value, thus achieving flat frequency characteristics. At the same time, thermal noise generated by the impedance converter 30 is attenuated in level with respect to the prescribed frequency band proximate to the resonance frequency fc. Thus, the silicon microphone 10 outputs signals having flat frequency characteristics, in which thermal noise is attenuated in level in proximity to the resonance frequency fc.

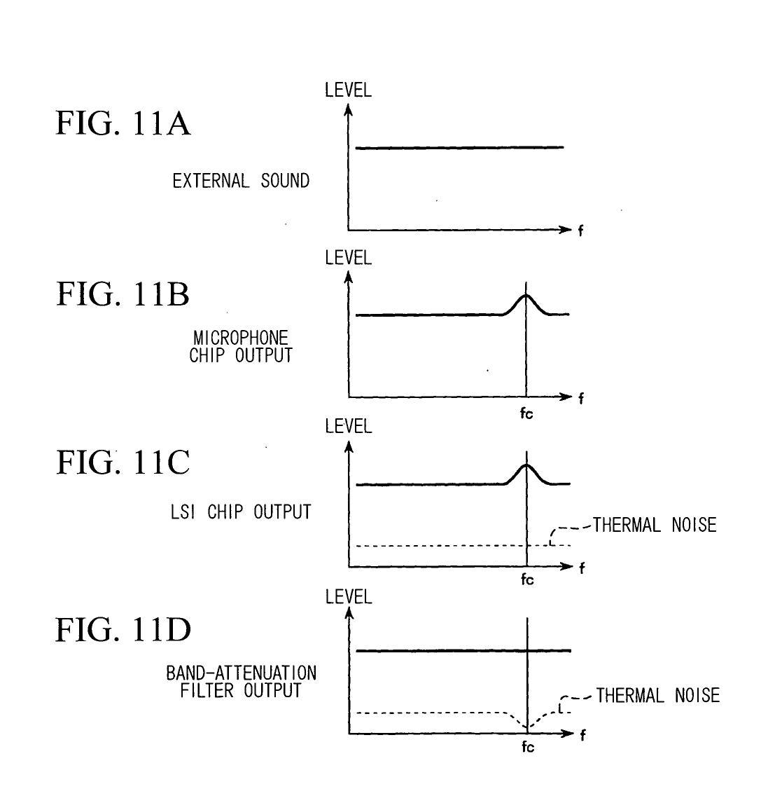

The operation of the electric circuitry of the silicon microphone 10 shown in FIG. 10 will be described with reference to FIGS. 11A to 11D, which show characteristics in the audio frequency band. FIG. 11A shows frequency characteristics of an external sound, which are presumably flat frequency characteristics. FIG. 11B shows frequency characteristics of an audio signal output from the microphone chip 14 of the silicon microphone 10 receiving the external sound, wherein the prescribed frequency band regarding the resonance frequency fc is increased in level due to resonance of the microphone package 12. FIG. 11C shows frequency characteristics of an audio signal output from the LSI chip 16, wherein a dotted line indicates thermal noise generated by the FET of the buffer amplifier 32 and the bias resistor 34 in the LSI chip 16. FIG. 11D shows the frequency characteristics of an audio signal output from the band-attenuation filter 38, wherein the prescribed frequency band including the resonance frequency fc in the input signal is selectively attenuated in level, thus achieving flat frequency characteristics. At the same time, thermal noise generated by the impedance converter 30 is attenuated with respect to the prescribed frequency band proximate to the resonance frequency fc. Thus, it is possible to improve the S/N ratio of the output signal of the silicon microphone 10.

### (B) Electronic Device Incorporating Condenser Microphone

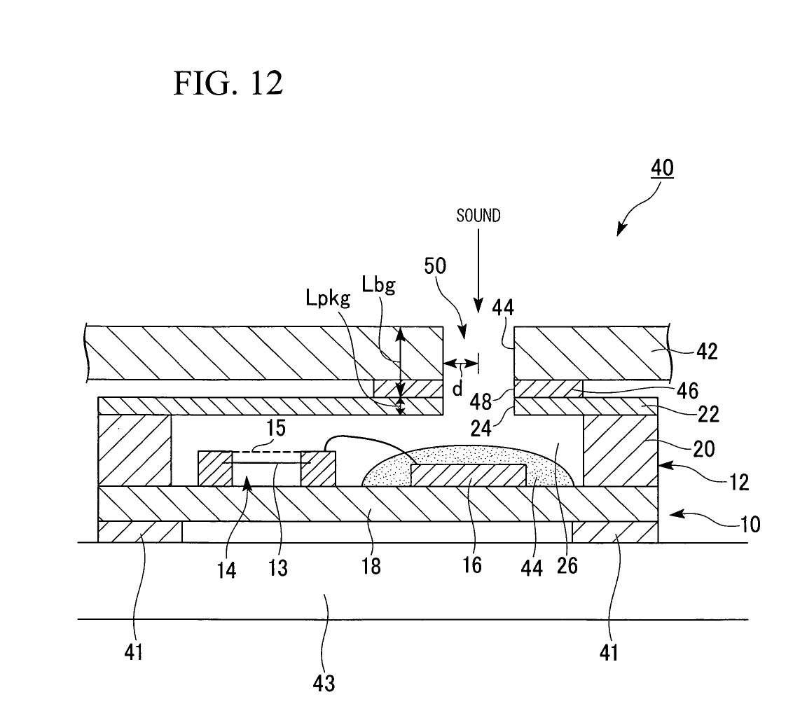

Next, an electronic device incorporating a condenser microphone (e.g., the silicon microphone 10) will be described with reference to FIGS. 12 to 17, wherein parts identical to those shown in the foregoing drawings are designated by the same reference numerals.

FIG. 12 is a longitudinal sectional view showing the constitution of a cellular phone (or a portable telephone terminal) 40 incorporating the silicon microphone 10. A sound hole 44 serving as a speech inlet is formed at a prescribed position of the front surface of a housing 42 of the cellular phone 40. The silicon microphone 10 is installed in the housing 42. The silicon microphone 10 has the terminals 41 formed on its backside surface, and the terminals 41 are soldered on a prescribed portion of a substrate 43 installed in the cellular phone so that the microphone 10 is fixed on the substrate 43. The constitution of the silicon microphone 10 is already described with reference to the foregoing drawings, wherein the silicon microphone 10 includes the microphone chip (or MEMS chip) 14 and the LSI chip 16, which are stored in the microphone package 12. The microphone package 12 is constituted by metal, ceramics, or resin, which forms a conductive layer and/or a printed circuit board. For example, the bottom 18 can be formed by a printed circuit board (or a substrate), the side walls 20 can be formed by ceramic or resin which forms a conductive layer, and the cover is formed using a thin metal plate. The microphone chip 14 and the LSI chip 16 are fixed onto the surface of the substrate 18. One sound hole 24 having a circular opening is formed at a prescribed position of the cover 22. The microphone chip 14 includes a diaphragm 13 and a back plate 15, which are positioned opposite to each other with a prescribed gap therebetween. The LSI chip 16 is sealed with a potting agent 45 in an airtight manner. The silicon microphone 10 is attached to the rear position of the front surface of the housing 42 so as to make the sound hole 24 communicate the sound hole 44. An airtight gasket 46 having a sound hole 48 is inserted between the silicon microphone 10 and the housing 42 so as to surround the sound holes 24 and 44. An external sound enters the sound hole 44 of the housing 42 and is transmitted through the sound hole 48 of the gasket 46 and the sound hole 24 of the housing 42, thus entering into the internal space 26 of the microphone package 12, in which it is received by the diaphragm 13 of the microphone chip 14. The LSI chip 16 includes an impedance converter and a filter, which perform impedance conversion and filtering on the output signal of the microphone chip 14. The output signal of the LSI chip 16 is extracted via the terminal 41 formed on the backside of the substrate 18 and is then supplied to an external circuit (e.g., an amplifier, not shown) formed on the substrate 43.

In FIG. 12, a through-hole (e.g. a duct or a port) 50 is formed by way of the sound hole 44 of the housing 42, the sound hole 48 of the gasket 46, and the sound hole 24 of the silicon microphone 10. The through-hole 50 communicates with the internal space 26 of the microphone package 12 so as to cause Helmholtz resonance. The resonance frequency of the Helmholtz resonance varies dependent upon the length of the through-hole 50 (i.e. the sum of the lengths of the sound holes 44, 48, and 24). The Helmholtz resonance frequency of the cellular phone 40 differs from the Helmholtz resonance frequency of the silicon microphone 10, which includes only the sound hole 24. Herein, the Helmholtz resonance frequency of the cellular phone 40 is lower than the Helmholtz resonance frequency of the silicon microphone 10. In the cellular phone 40, the Helmholtz resonance frequency is set to a desired frequency within the audio frequency range, and frequency components (including components of the Helmholtz resonance frequency) of the output signal of the impedance converter are selectively attenuated by means of a band attenuation device, thus achieving the flat frequency characteristics in the output signal of the silicon microphone 10.

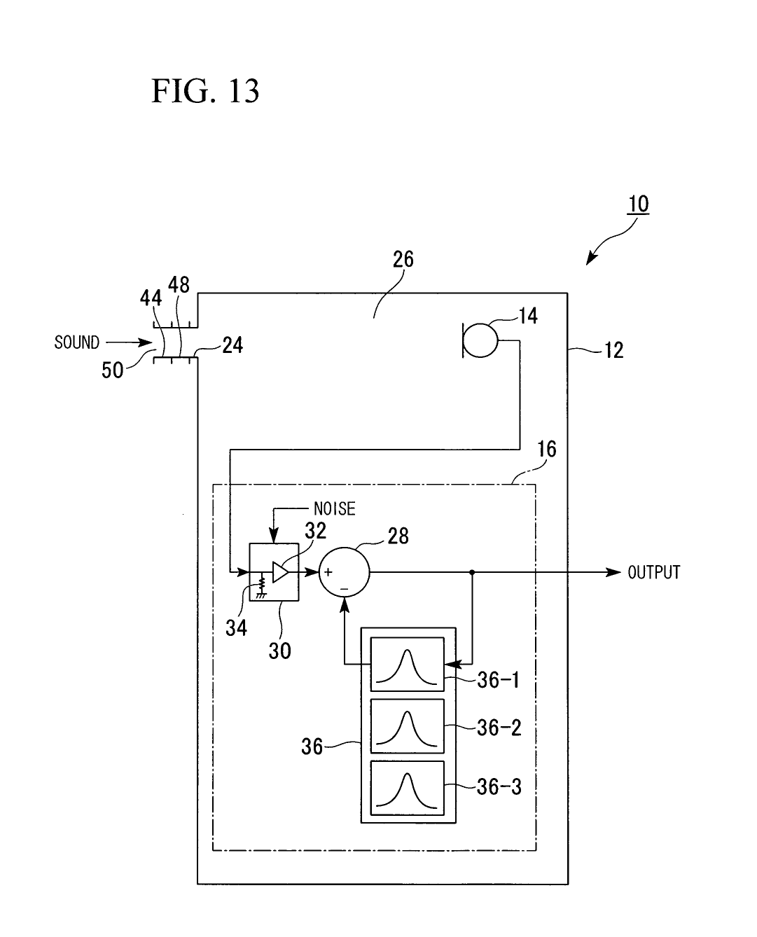

FIG. 13 shows the electric circuitry of the silicon microphone 10 installed in the cellular phone 40 shown in FIG. 12, wherein its power system is not shown. An external sound enters the opening of the through-hole 50 (which interconnects the sound hole 44 of the housing 42, the sound hole 48 of the gasket 46, and the sound hole 24 of the silicon microphone 10 together) and is then received by the microphone chip 14 via the internal space 26. The output signal (i.e., the microphone signal) of the microphone chip 14 is supplied to the LSI chip 16. The microphone signal is subjected to impedance conversion by the impedance converter 30. The impedance converter 30 is constituted by the buffer amplifier 32 (configured using FETs) and the bias resistor 34 (which is provided at the input terminal of the buffer amplifier 32 and whose resistance ranges from several giga-ohms to several tera-ohms). Thermal noise (or white noise) generated by the FETs of the buffer amplifier 32 and the bias resistor 34 reduces the S/N ratio of the output signal of the silicon microphone 10. The microphone signal already subjected to impedance conversion is supplied to the band-pass filter 36 via the subtracter 28, thus extracting a signal having a prescribed frequency band including the resonance frequency fc. The extracted signal is subjected to gain adjustment and is then fed back to the subtracter 28. The subtracter 28 subtracts the signal having the prescribed frequency band including the resonance frequency fc from the input signal. Thus, the input signal is selectively attenuated in level with respect to the prescribed frequency band including the resonance frequency fc, thus achieving the flat frequency characteristics. This makes it possible to attenuate thermal noise generated by the impedance converter 30 with respect to the prescribed frequency band including the resonance frequency fc, thus improving the S/N ratio. That is, the silicon microphone 10 outputs signals having the flat frequency characteristics, in which signal components corresponding to thermal noise lying in proximity to the prescribed frequency band including the resonance frequency fc are attenuated. The aforementioned operation of the electric circuitry shown in FIG. 13 is already described with reference to FIGS. 9A to 9E.

The band-pass filter 36 has a plurality of filter characteristics 36-1, 36-2, and 36-3 having different center frequencies, which are preset in advance. Hence, the band-pass filter 36 selectively uses one of the filter characteristics 36-1 to 36-3, the center frequency of which matches or is close to the resonance frequency fc of the cellular phone 40 incorporating the silicon microphone 10. In the case of the cellular phone 10, dimensions and sizes of the housing 42 and the gasket 46 do not greatly deviate among different models; hence, the silicon microphone 10, which selectively uses one of the preset filter characteristics 36-1 to 36-3, can be adapted to any types of models. For example, when the total thickness of the housing 42 and the gasket 46 is set to 1 cm or so, the resonance frequency fc is approximately 6 kHz; and when the total thickness is set to 1 mm or so, the resonance frequency fc is approximately 13 kHz. That is, the aforementioned filter characteristics 36-1 to 36-3 are determined in advance to cover the aforementioned frequency range. Specifically, the silicon microphone 10 is actually installed in the housing 42 of the cellular phone 10 so as to measure the resonance frequency fc; then, the filter characteristics whose center frequency is close to the measured resonance frequency fc is selected and used in the band-pass filter 36 of the LSI chip 16 installed in the silicon microphone 10, which is thus modified in filter characteristics to suit the housing 42 of the cellular phone 10. When the band-pass filter 36 is configured using a digital filter, filter coefficients achieving the filter characteristics 36-1 to 36-3 are stored in a memory (not shown) of the LSI chip 16 in advance. Upon a filter characteristics selecting operation, the corresponding filter coefficients are read from the memory and are then set to the digital filter.

Next, actual values used for the design of the cellular phone 40 will be descried below.

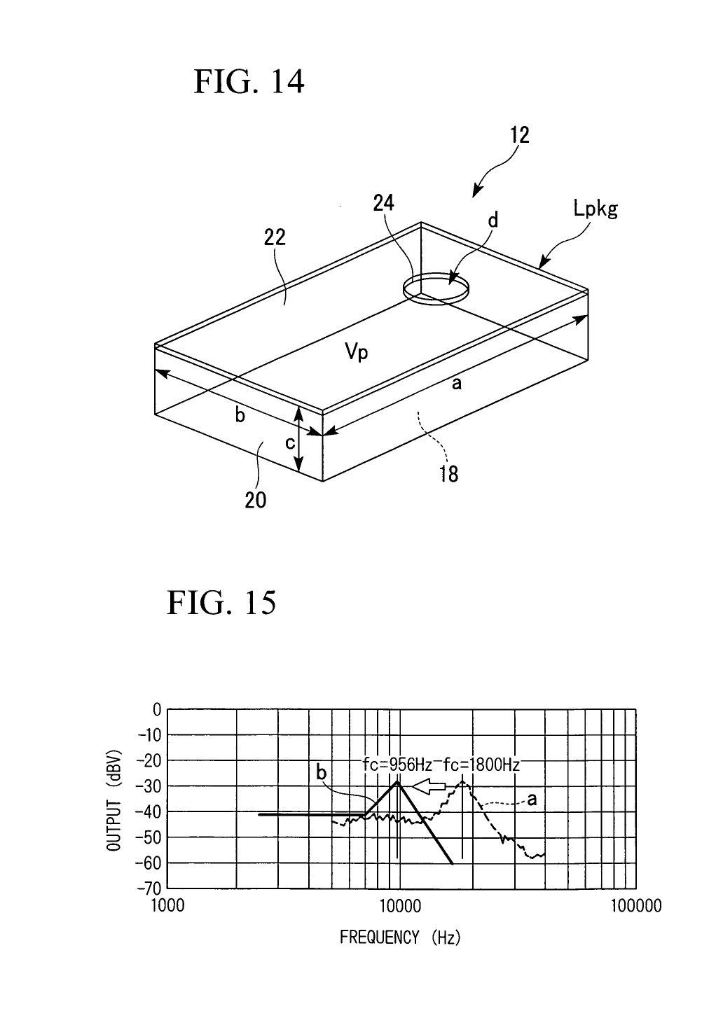

(a) Microphone package 12 (having a rectangular parallelepiped shape, see FIG. 14)

Length: a=3.7 mm

Width: b=2.45 mm

Height: c=0.775 mm

Radius of sound hole 24: d=0.38 mm

Volume (a×b×c): Vpkg=7.03×10⁻⁹ m²

Area of sound hole (πd²): D=4.54×10⁻⁷ m²

Thickness of cover 22: Lpkg=1.00×10⁻⁴ m

(b) Microphone chip 14 (having a rectangular parallelepiped shape)

Length: 1.6 mm

Width: 1.6 mm

Height: 0.3 mm

Volume: Vmic=1.36×10⁻⁹ m³

(c) LSI chip 16 (having a rectangular parallelepiped shape)

Length: 1.5 mm

Width: 1.5 mm

Height: 0.3 mm

Volume: Vlsi=6.75×10⁻¹⁰ m³

(d) Potting agent 45

Volume (substantially identical to the volume of the microphone chip 14):

Vpt=1.36×10⁻⁹ m³

### (e) Housing 42 and Gasket 46

Radius of sound holes 44 and 48 (identical to the sound hole 24 of the microphone package 12): d=0.38 mm

Areas of sound holes 44 and 48 (πd²): D=4.54×10⁻⁷ m²

Total thickness of housing 42 and gasket 46: (Ex) Lbg=3.00×10⁻³ m

Thus, it is possible to calculate the Helmholtz resonance frequency fc of the silicon microphone 10, which is designed using the aforementioned values of the items (a) to (d), as follows:

Air density: ρ=1.23 kg/m³

Speed of sound: c=343 m/sec

Effective volume: Vp=Vpkg−Vmic−Vlsi−Vpt=3.64×10⁻⁹ m³

Number of sound hole(s): n=1

Sectional area of sound hole 24: D=4.54×10⁻⁷ m²

Radius of sound hole 24: d=0.00038 m

Length of sound hole 24: L (=Lpkg)=1.00×10⁻⁴ m

Stiffness: s (=ρ·c²·D²/Vp)=8.19 N/m

Correction coefficient for opening edge: r=2.546481

Correction value: r·d=0.000968

Mass: m (=ρ·n·D·(L+r·d))=5.96×10⁻¹⁰ kg

Helmholtz resonance frequency: fc (=½π·(s/m)^{1/2})=18666 Hz

In this connection, the actually measured value of the Helmholtz resonance frequency fc of the silicon microphone 10, which is designed using the aforementioned values of the items (a) to (d), is 18000 Hz.

Next, the Helmholtz resonance frequency fc is calculated with respect to the silicon microphone 10 incorporated in the housing 42 (see FIG. 12) in accordance with the aforementioned values of the items (a) to (e), as follows:

Air density: ρ=1.23 kg/m³

Speed of sound: c=343 m/sec

Effective volume: Vp=Vpkg−Vmic−Vlsi−Vpt=3.64×10⁻⁹ m³

Number of sound hole(s): n=1

Sectional area of sound hole 24: D=4.54×10⁻⁷ m²

Radius of sound hole 24: d=0.00038 m

Length of sound hole 24: L (=Lpkg+Lbg)=3.10×10⁻³ m

Stiffness: s (=ρ·c²·D²/Vp)=8.19 N/m

Correction coefficient for opening edge: r=2.546481

Correction value: r·d=0.000968

Mass: m (=ρ·n·D·(L+r·d))=2.27×10⁻⁹ kg

Helmholtz resonance frequency: fc (=½π(s/m)^{1/2})=9560 Hz

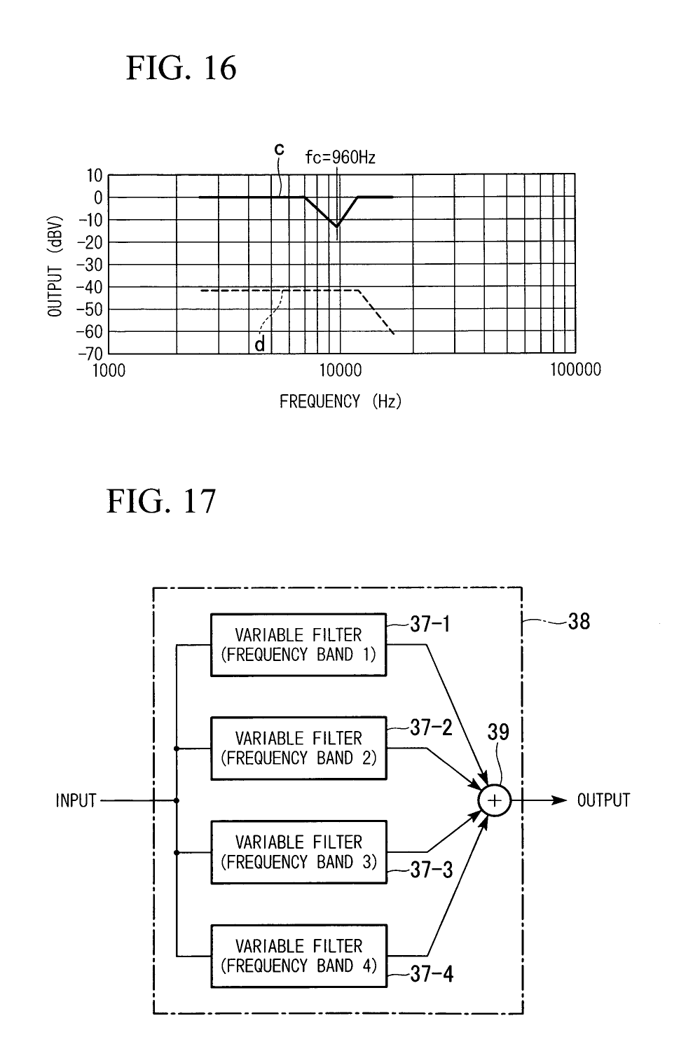

In FIG. 15, frequency characteristics “a” show actually measured values of frequency characteristics of the silicon microphone 10, which is designed using the aforementioned values of the items (a) to (d), without filtering; and frequency characteristics “b” show calculated values of frequency characteristics of the silicon microphone 12 installed in the housing 42 of the cellular phone 40, which is designed using the aforementioned values of the items (a) to (e), without filtering. The frequency characteristics a and b clearly show that the Helmholtz resonance frequency fc decreases when the silicon microphone 10 is installed in the housing 42 of the cellular phone 40. In consideration of this phenomenon, filter characteristics “c” shown in FIG. 16 are set to an attenuation device configured by the band-pass filter 36 and the subtracter 28 based on the frequency characteristics b of the silicon microphone 10 installed in the housing 42 of the cellular phone 40. Due to the filter characteristics c, the output signal of the silicon microphone 10 is attenuated in level with respect to the prescribed frequency band whose center frequency substantially matches the Helmholtz resonance frequency fc that occurs when the silicon microphone 10 is installed in the housing 42 of the cellular phone 40. That is, the output signal of the silicon microphone 10 having the frequency characteristics b is subjected to filtering using the filter characteristics c, thus achieving flat output characteristics d shown in FIG. 16.

The aforementioned attenuation device includes only a single filter (i.e., the band-pass filter 36), but this is not a restriction. That is, it is possible to use a plurality of filters having preset attenuations in units of bands within the audio frequency band similar to the conventionally-known graphic equalizer. For example, the band-attenuation filter 38 is configured as a filter bank in which the audio frequency range is divided into a plurality of frequency bands 1, 2, 3, and 4, for which individual variable filters 37-1, 37-2, 37-3, and 37-4 are provided. Different gains such as −10 dB, −5 dB, −3 dB, 0 dB, and +3 dB can be set to the variable filters 37-1 to 37-4, for example. That is, the resonance frequency fc of the silicon microphone 10 actually installed in the housing 42 of the cellular phone 40 is actually measured; then, desired gains are individually set to the variable filters 37-1 to 37-4 so as to effectively attenuate the components of the resonance frequency fc in the output signal of the silicon microphone 10. These gains can be commonly used for a specific model of the cellular phone 40 having the housing 42. In the band-attenuation filter 38 shown in FIG. 17, the output signal of the impedance converter 30 (see FIG. 10) is supplied to all the variable filters 37-1 to 37-4, in which it is applied to the prescribed gains in units of frequency bands, thus effectively attenuating signal components with respect to the prescribed frequency band whose center frequency substantially matches the resonance frequency fc. The output signals of the variable filters 37-1 to 37-4 are added together by an adder 39, the output signal of which is then output from the silicon microphone 10.

The present embodiment and its modified example are designed as applications to silicon microphones; but this is not a restriction. They can be applied to other types of condenser microphones (including electret condenser microphones) other than silicon microphones.

The present embodiment and its modified example use microphone packages which have sound holes each arranged on the upper surface of the package. But the sound holes are not each restricted to be arranged on the upper surface of the microphone package. The sound holes may be each arranged on the bottom surface or the side surface of the package. In this case, a gasket can be inserted between the microphone package and the housing of an electronic device so that the sound hole of the microphone package communicates with the sound hole of the housing via the opening of the gasket.

Lastly, the present invention is not necessarily limited to the present embodiment, which can be further modified in a variety of ways within the scope of the invention as defined in the appended claims.

What is claimed is:

1. A method for improving an S/N ratio of a condenser microphone including a microphone chip, which is stored in a microphone package so as to receive an external sound propagated thereto via a sound hole of the microphone package, comprising the steps of:
setting a resonance frequency of Helmholtz resonance, which occurs due to the sound hole and an internal space of the microphone package, to an audio frequency range;
supplying an output signal of the microphone chip to an impedance converter; and
selectively attenuating an output signal of the impedance converter with respect to a prescribed frequency band including the resonance frequency, thus achieving flat frequency characteristics.

2. A method for improving an S/N ratio of a condenser microphone installed in a housing of an electronic device, wherein the condenser microphone includes a microphone chip, which is stored in a microphone package having a sound hole, said method comprising the steps of:
installing the microphone package in the housing of the electronic device with the sound hole of the microphone package communicated with a sound hole of the housing so as to receive an external sound propagated thereto via the sound hole of the housing and the sound hole of the microphone package;
setting a resonance frequency of Helmholtz resonance, which occurs due to the sound hole of the housing, the sound hole of the microphone package, and an internal space of the microphone package, to an audio frequency range;
supplying an output signal of the microphone chip to an impedance converter; and
selectively attenuating an output signal of the impedance converter with respect to a prescribed frequency band including the resonance frequency, thus achieving flat frequency characteristics.

3. The method for improving the S/N ratio of a condenser microphone according to claim 1, wherein the resonance frequency ranges from 500 kHz to 10 kHz.

4. The method for improving the S/N ratio of a condenser microphone according to claim 2, wherein the resonance frequency ranges from 500 kHz to 10 kHz.

5. The method for improving the S/N ratio of a condenser microphone according to claim 1, wherein the resonance frequency is set to 6 kHz±1 kHz.

6. The method for improving the S/N ratio of a condenser microphone according to claim 2, wherein the resonance frequency is set to 6 kHz±1 kHz.

7. A condenser microphone comprising:
a microphone package having a sound hole and an internal space, wherein the microphone package is designed such that a resonance frequency of Helmholtz resonance is set to an audio frequency range;
a microphone chip that is stored in the microphone package so as to receive an external sound entering into the sound hole via the internal space of the microphone package;
an impedance converter for performing impedance conversion on an output signal of the microphone chip; and
an attenuation device for selectively attenuating an output signal of the impedance converter with respect to a prescribed frequency band including the resonance frequency, thus achieving flat frequency characteristics.

8. A condenser microphone installed in a housing of an electronic device, comprising:
a microphone package having an internal space and a sound hole communicated with a sound hole of the housing, wherein the microphone package installed in the housing is designed such that a resonance frequency of Helmholtz resonance is set to an audio frequency range;
a microphone chip that is stored in the microphone package so as to receive an external sound propagated thereto via the sound hole of the housing, the sound hole of the microphone package, and the internal space of the microphone package;
an impedance converter for performing impedance conversion on an output signal of the microphone chip; and
an attenuation device for selectively attenuating an output signal of the impedance converter with respect to a prescribed frequency band including the resonance frequency, thus achieving flat frequency characteristics.

9. A condenser microphone according to claim 7, wherein the impedance converter and the attenuation device are arranged in the internal space of the microphone package.

10. A condenser microphone according to claim 8, wherein the impedance converter and the attenuation device are arranged in the internal space of the microphone package.

11. A condenser microphone according to claim 7, wherein the attenuation device includes a band-pass filter for extracting the prescribed frequency band including the resonance frequency from the output signal of the impedance converter, and a subtracter for subtracting the prescribed frequency band extracted by the band-pass filter from the output signal of the microphone chip so as to feed back a subtraction result thereof to the impedance converter.

12. A condenser microphone according to claim 8, wherein the attenuation device includes a band-pass filter for extracting the prescribed frequency band including the resonance frequency from the output signal of the impedance converter, and a subtracter for subtracting the prescribed frequency band extracted by the band-pass filter from the output signal of the microphone chip so as to feed back a subtraction result thereof to the impedance converter.

13. A condenser microphone according to claim 7, wherein the attenuation device includes a band-attenuation filter for attenuating the prescribed frequency band including the resonance frequency from the output signal of the impedance converter.

14. A condenser microphone according to claim 8, wherein the attenuation device includes a band-attenuation filter for attenuating the prescribed frequency band including the resonance frequency from the output signal of the impedance converter.

15. A condenser microphone according to claim 7, wherein the attenuation device has a plurality of attenuation characteristics, one of which is selectively used to attenuate the prescribed frequency band.

16. A condenser microphone according to claim 8, wherein the attenuation device has a plurality of attenuation characteristics, one of which is selectively used to attenuate the prescribed frequency band.

17. A condenser microphone according to claim 7, wherein the attenuation device has a plurality of attenuation values, which are set to a plurality of frequency bands within the audio frequency range.

18. A condenser microphone according to claim 8, wherein the attenuation device has a plurality of attenuation values, which are set to a plurality of frequency bands within the audio frequency range.

19. An electronic device having a housing and incorporating a condenser microphone, which includes
a microphone package having an internal space and a sound hole communicated with a sound hole of the housing, wherein the microphone package installed in the housing is designed such that a resonance frequency of Helmholtz resonance is set to an audio frequency range,
a microphone chip that is stored in the microphone package so as to receive an external sound propagated thereto via the sound hole of the housing, the sound hole of the microphone package, and the internal space of the microphone package,
an impedance converter for performing impedance conversion on an output signal of the microphone chip, and
an attenuation device for selectively attenuating an output signal of the impedance converter with respect to a prescribed frequency band including the resonance frequency, thus achieving flat frequency characteristics.

20. The method of improving the S/N ratio of a condenser microphone according to claim 2 further including a gasket having a sound hole which is arranged between the microphone package and the housing of the electronic device so as to surround the sound hole of the microphone package and the sound hole of the housing.
